(19) United States
(12) Patent Application Publication
(10) Pub. No.: US 2004/0071533 A1
(43) Pub. Date: Apr. 15, 2004

(54) Portable wheel stopper system

(76) Inventor: Hironobu Kondo, Nerima-Ku (JP)

Correspondence Address: Hironobu KONDO, Ohizumigakuen-cho 6-1-12, Nerima-ku, Tokyo, 179-0076 (JAPAN), JP

(21) Appl. No.: 10/267,123

(22) Filed: Oct. 10, 2002

(51) Int. Cl. B65G 67/00

(52) U.S. Cl. 414/401

(57) ABSTRACT

A portable wheel stopper system for car parking having tire receiver portion to receive car tire in case of stopping, having wheel stopping portion connected to said tire receiver, said wheel stoppin portion shaped as roughly triangular so that said tire receiver can be tied round said wheel stopping portion to form one body, said tire receiver can be rolled in in case of no use, said wheel portion equipped with reflector that is used for confirming a distance between tire receiver and car driver for safe parking.

### BACKGROUND OF THE INVENTION

The present invention relates to a portable wheel stopper for car parking.

The device of my invention is compact in size and handy for carrying about, and in case of car parking in file (lengthwise parking) the portable wheel stopper of my invention enable a driver to park his car safely and quickly at desired space in the city street.

### DESCRIPTION OF THE PRIOR ART

A conventional wheel stoppers heretofore used is based on the principle that such car stopper must be fixed solidly onto the ground or floor of car parking space semipermently, hence very hard to remove or carry off to other places. Stillmore, even if granted that we can remove them to other places, it is very hard to replace them to other places since almost all of them are made of metal material and thick and heavy.

### SUMMARY OF THE INVENTION

The primary object of my invention is to present a unique portable wheel stopper system for car parking. Since made in compact, my invention is very easy to carry about in case of no use, and very convenianly used in using. The present invention is composed of following portions, namely, a tire receiver to receive car tire drived and mounted on said tire receiver, and a car stopping portion fixed to said tire receiver at its end portion to stop said car tire driven and mounted on the tire receiver. The tire receiver is made of flexible, bendable material of sheet state, and the cross section of said car stopper portion is shaped as of roughly triangular so that said tire receiver can be tied round said car stopper portion as one body.

The tire receiver can be unrolled in case of use.

Still more, the reflector are fixed onto outer surfaces, right and left sides of said car stopper portion so that car driver be able to evade risk of touching other's cars by seeing reflected light of said reflectors.

The tire receiver is made of rubber or plastic materials to be easily bent or to be extended. The wheel stopper system comprises the hook portion mounted on said tire receiver and detouchable clasp portion fixed to car stopping portion so as to detuchable to said hook portion by which device, hooking and unhooking can be handled by one hand.

### BRIEF DESCRIPTION OF THE DRAWING

Now, description will be made on the drawings.

FIG. 1 is a perspective view of the invention showing the external apperance of the wheel stopper system for car parking while in use;

FIG. 2 is a perspective view of the device before use;

FIG. 3 is a perspective view of the device showing a rear external appearance while in use;

FIG. 4 is a sectional view of the device taken from side direction before use;

FIG. 5-a is a side sectional view of the device in which a tire receiver 5 is completely folded before use;

FIG. 5-b is a side sectional view of the device in which the tire receiver 5 is semiunfolded before use;

FIG. 5-c is a side sectional view of the device in which the tire receiver 5 is half-extended before use;

FIG. 5-d is a side sectional view of the device in which the tire receiver 5 is fully unfolded and extended ready for use;

FIG. 6 is a perspective diagram of the device in which a wheel tire is mounted on the tire receiver;

FIG. 7-1 is a side elevational view of the tire receiver shaped of single crease;

FIG. 7-2 is a side evevational view of the tire receiver 5 shaped of double crease;

FIG. 7-3 is a side elevational view of the tire receiver shaped of mesh type;

FIG. 8 is a perspective view of the device before use taken from rear side in which an advertising space 15 and handhold are deviced.

FIG. 9 is a perspective view of the device before use taken from rear side in which the tire receiver 5 is completely folded and hooked with handhold 10.

### REFERENTIAL NUMERALS

4 Portable wheel stopper system

5 Tire receiver

5-1 Single crease

5-2 Double crease

5-3 Mesh type

6 Wheel stopping portion

7 Reflector

8 Slant face

9 Concaved ditch

10 Hook to be hooked

11 Tire receiver fixing bolts

12 Hooking hole

13 Tire

14 Tire fitting flute

15 Advertising board

A Rolling face

B Rolling face

C Rolling face

### DETAILED DESCRIPTION OF THE INVENTION

The wheel stopper system for car parking 4 of my invention is composed of tire receiver 5 to receive wheel tire on its belt-like receiver portion and wheel stopping portion 6 fixed at the end portion of the tire receiver 5.

The wheel stopping portion 6 is to stop the rotation of wheel tire coming and mounted on the tire receiver 5. The tire receiver 5 is preferably made of synthetic resin rubber to shape a sheet-like flexible product to be easily bent and one end portion thereof is fixed to wheel stopping portion 6.

The cross section of said wheel stopping portion 6 is shaped as of roughly triangular.

The wheel stopping portion 6 has three faces such as A, B and C, width of which is as same width as that of tire receiver 5, so that the tire receiver 5 can be folded around said wheel stopping portion 6 in no use.

At both side of end portion of the wheel stopping portion 6 two reflectors are proviced so that driver of the car easily see and confirm the car stopping position by reflector.

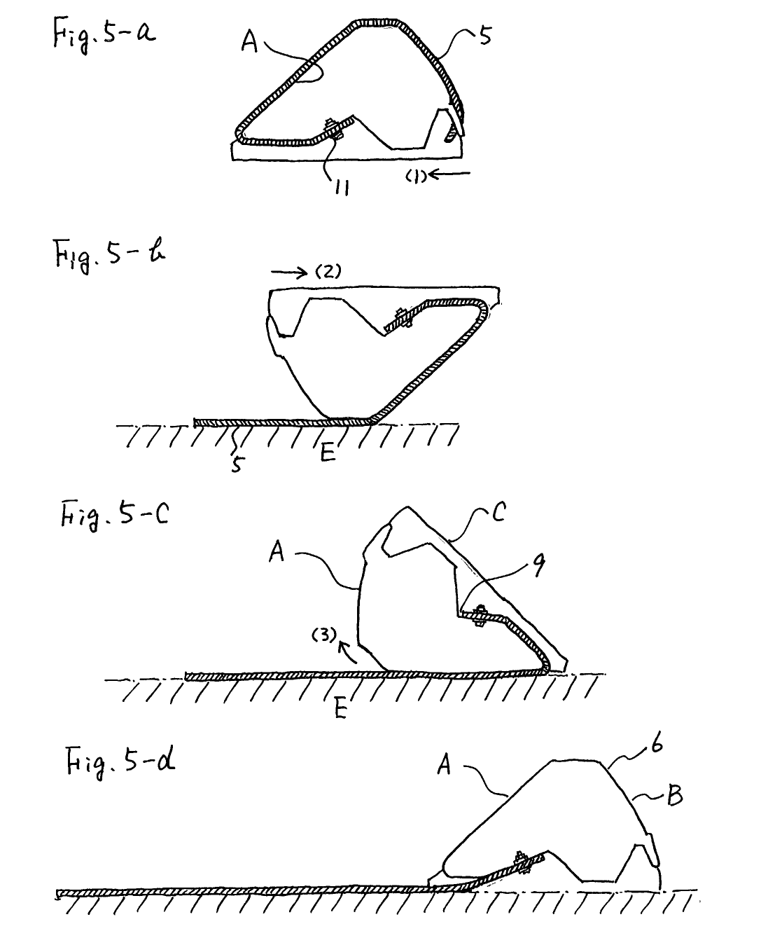

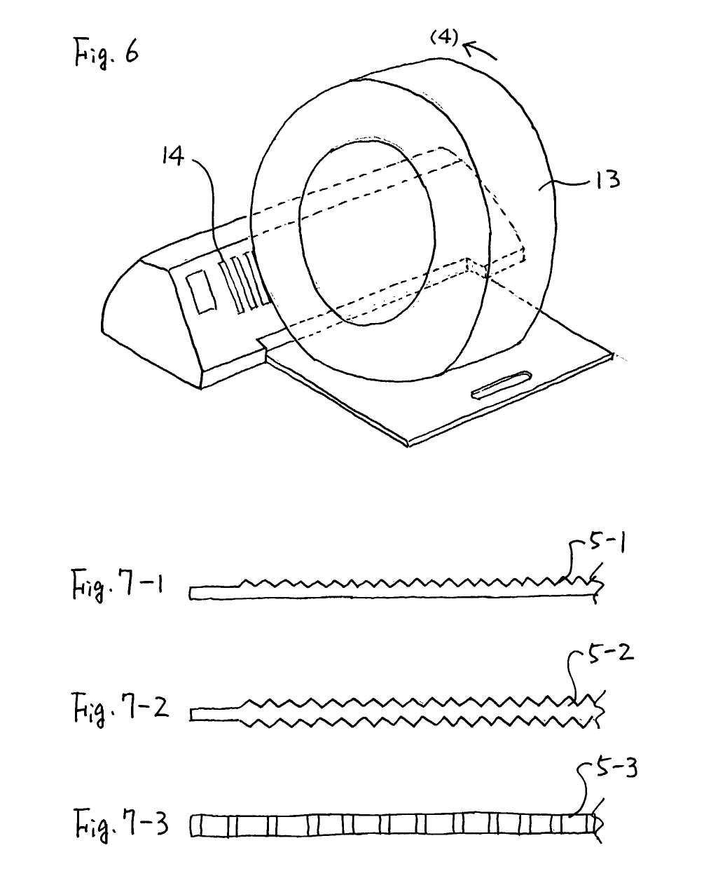

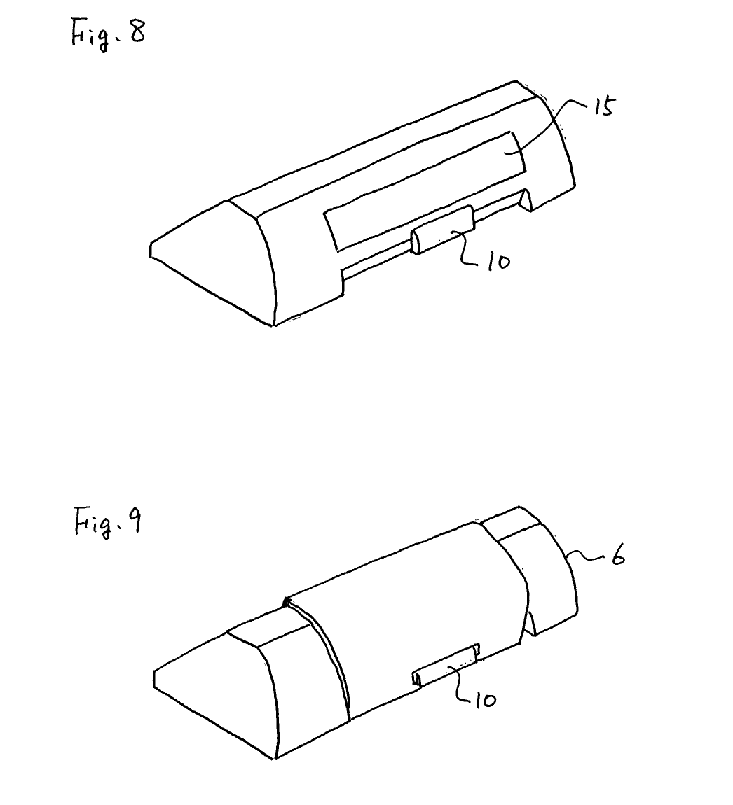

As shown in FIG. 2, FIG. 4˜FIG. 6, to begin, take out the portable wheel stopper system 4 from a car trunk. At this time the tire receiver 5 remained folded around the wheel stopping portion 6 (FIG. 2, FIG. 5-a). Then, we draw a hooking hole 12 out hook 10 (FIG. 4) and extend toward the direction as shown by arrow sign (FIG. 5b). Then, wheel stopping portion 6 is rotated toward arrow-signed direction (FIG. 5-b) to unfold from the tire receiver 5 (FIG. 5-c) off a rolling face B (FIG. 5-c), and again rotate the wheel the wheel stopping portion 6 toward direction of arrow sign (3) to unfold said wheel stopping portion 6 off rolling face A and extend the tire receiver 5 on the ground E (FIG. 5-d).

Thus, portable wheel stopper system 4 is ready for operation at prescribed place (FIG. 6).

Then, a car is slowly driven back to be parked on the tire receiver 5. In this case the driver carefully operate his car seeing a distance between rear wheels of the car and wheel stopping portion 6 by reflector 7 provided at both side portion of the wheel stopping portion 6. Thus, the car would correctly stop at appointed place when the tire 13 touch the rolling face A of the wheel stopper system 4. In this case of parking, burden of the car weighed on tire receiver 5 through tire 13 so that portable wheel stopper system 4 don't move and keep original place.

In case of portable wheel stopper system not in use, the tire receiver 5 is winded up round the wheel stopping portion 6 and hooking hole 12 is hooked onto the hook 10. In this case a fastener method may be employed instead of above described hooking hole means. Thus, the tire receiver 5 can be folded up very compactly and easily.

According to my invention, the tire receiver 5 is easily accomodated onto the wheel stopping portion 6 by rolling it around the stopping portion 6.

Furthermore, easy detaching of the hooking hole 12 off the hook 10 make it possible to remove and extend the tire receiver 5 off the wheel stopping portion 6 for practical use.

Stillmore, the portable wheel stopper system 4 of my invention is made so slightly so that handy to carry about in a trunk of car.

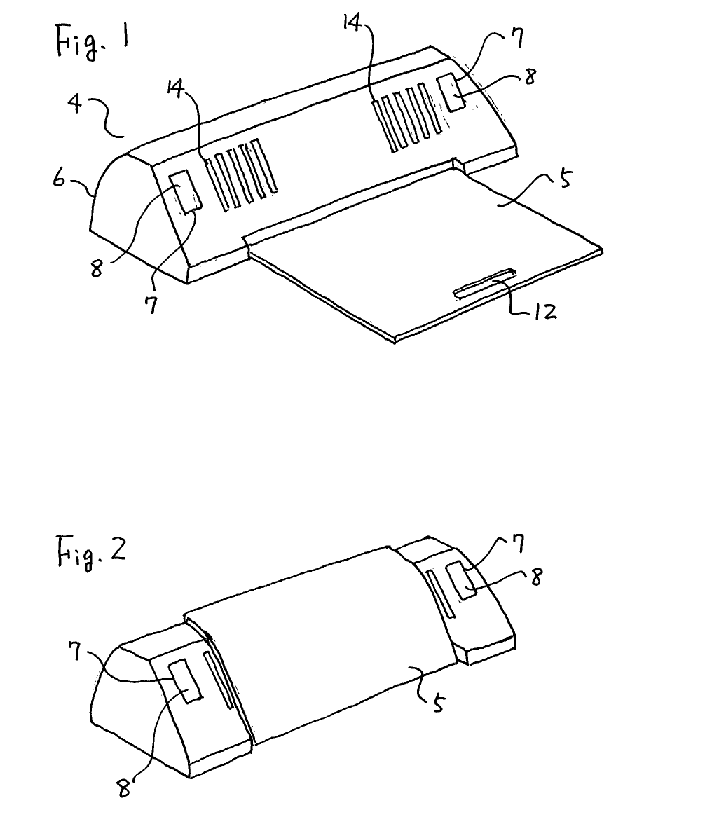

On the other hand, a driver can see and confirm the backward of the car by reflector 7 (FIG. 1 and FIG. 2), and safely park at fixed place without touching a car on the body of other persons.

Moreover, in my invention winded tire receiver 5 is fixed by putting the hooking hole 12 to the hook, but instead of this device, means of providing a fastener at head position of the tire receiver 5 and at the rolling face C, thus each fastener can be fastened when they adapted each other after tire receiver rolled up.

Stillmore, snap connecting means can be employed instead of above described methods

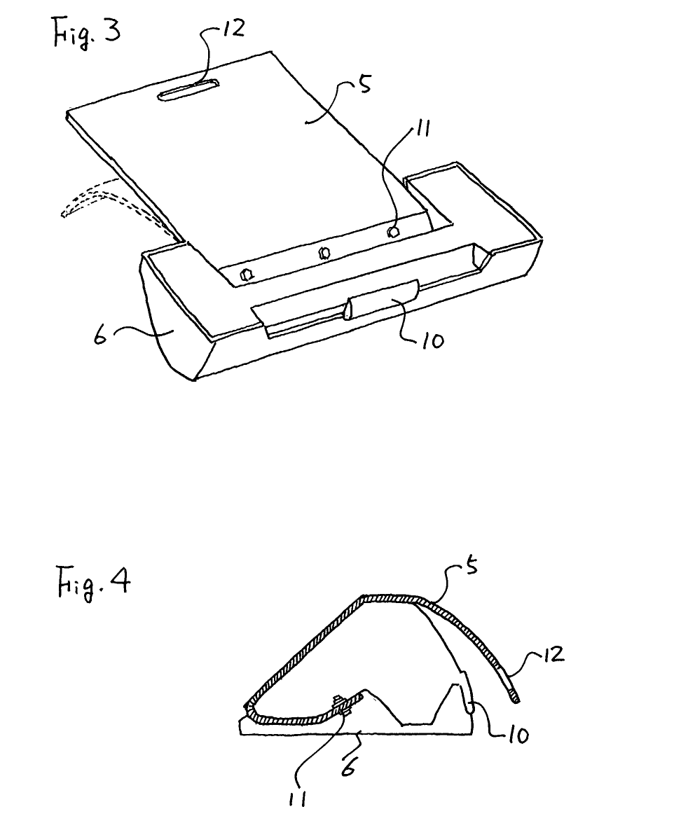

In the above described embodiment of my invention, tire receiver is made of rubber material, but plastic material may be employed instead. To make it easy to wind the tire receiver 5 round the wheel stopping portion 6 single crease or double crease can be provided on the surface of the tire receiver 5, or the mesh type of the tire receiver can be adviced (FIG. 7-1˜FIG. 7-3).

Stillmore, two portable wheel stopper systems of my invention may be used to prevent rear wheels from backward moving.

What is claimed is:

1. A portable wheel stopper system for car parking having a tire receiver to receive wheel tire when the tire mounted on the tire receiver, having wheel stopping portion connected to one end of said tire receiver to stop the movement of said wheel tire, said receiver is made in flexible, bendable material to be sheet state, a cross section of said wheel stopping portion is shaped as roughly triangular so that said tire receiver can be tied round said wheel stopping portion to one body each other, said tire receiver can be unrolled from said wheel stopping system in case of use.

2. A portable wheel stopper system for car parking according to claim 1, in which reflectors fixed to outer surfaces of said wheel stopping portion so that the car driver can evade touching other cars by reflected light of reflector.

3. A wheel stopper system for car parking having wheel stopper portion and tire receiver according to claim 1 and 2, said tire receiver being made of rubber or plastic material.

4. A wheel stopper system for car parking as in claims 1˜3, further comprising hook portion mounted on said tire receiver and detachable clasp fixed to wheel stopper portion so as to detachable from said hook portion, by which device hooking and unhooking is handled by one hand.
